(19) United States
(12) Patent Application Publication
(10) Pub. No.: US 2012/0218185 A1
(43) Pub. Date: Aug. 30, 2012

(54) NON-DIRECTIONAL MOUSE

(75) Inventor: Yi-Guang Chen, Taipei (TW)

(73) Assignee: PRIMAX ELECTRONICS LTD., Taipei (TW)

(21) Appl. No.: 13/079,674

(22) Filed: Apr. 4, 2011

(30) Foreign Application Priority Data
Feb. 25, 2011 (TW) 100106392

(51) Int. Cl. G06F 3/033

(52) U.S. Cl. 345/163

(57) ABSTRACT

A non-directional mouse includes a casing, plural touch-sensitive modules and a controlling unit. When a first finger and a second user of a user are placed on the casing and detected by the touch-sensitive modules, the controlling unit determines an operating coordinate system. Regardless of whether the orientation of the mouse is, the non-directional mouse can be operated with respect to the operating coordinate system corresponding to the hand gesture of the user.

### FIELD OF THE INVENTION

The present invention relates to an input device, and more particularly to a mouse for use with a computer system.

### BACKGROUND OF THE INVENTION

The common computer input device includes for example a mouse, a keyboard, a trackball, a touchpad, and the like. Among these input devices, the mouse is the most prevailing because it complies with the usual practices of most users. When a mouse is held by a user's palm, the user may move the mouse to control movement of the cursor shown on the computer screen.

FIG. 1 schematically illustrates the connection between a conventional mouse and a computer system. The computer system 2 comprises a computer host 21 and a computer monitor 22. The computer host 21 is in communication with a wheel mouse 1 and the computer monitor 22. A graphic-based window 221 and a cursor 222 are shown on the computer monitor 22. The wheel mouse 1 is used for controlling the cursor 221 to have the computer host 21 execute a corresponding command. The wheel mouse 1 comprises a casing 10, a left button 11, a right button 12 and a scroll wheel 13. The casing 10 is used for supporting a user's palm P (see FIG. 2). When the casing 10 is moved by the user to result in a displacement amount, the computer host 21 correspondingly moves the cursor 222 shown on the computer monitor 22 according to the displacement amount. By clicking the left button 11 or the right button 12, a control signal is issued to the computer host 21. In response to the control signal, the computer host 21 executes a corresponding command. The scroll wheel 13 is arranged between the left button 11 and the right button 12. By rotating the scroll wheel 13, a scrolling signal is generated. In response to the scrolling signal, the computer host 21 executes a function of scrolling the graphic-based window 221. The basic functions of the wheel mouse have been described above.

However, the mouse having the basic functions fails to meet the user's requirements. For complying with different conditions, a variety of mice with diverse functions have been introduced into the market. The mice with diverse functions include for example a wireless mouse with no physical connecting wire, a tilt wheel mouse having a function of horizontally moving the graphic-based window, a motion sensitivity adjustable mouse, a slim mouse with a small volume, or a camera mouse having a shooting function. Regardless whether any special mouse is used, after the user's palm P is placed on the casing 10, a first finger F1 is placed on the left button 11 and a second finger F2 is placed on the right button 12, the user may start to manipulate the mouse 1 (see FIGS. 2 and 3A).

FIG. 3A is a schematic top view illustrating the conventional mouse operated by a first user. As shown in FIG. 3A, an original coordinate system X-Y has been previously set in a displacement sensing element (not shown) within the conventional mouse 1. The original coordinate system X-Y comprises a first original axis Y and a second original axis X. The second original axis X is perpendicular to the first original axis Y. The first original axis Y is a vertical axis. The second original axis X is a horizontal axis. In a case that the mouse 1 is operated by a first user, since the hand gesture of the first user is in coincidence with the original coordinate system X-Y of the mouse 1, the cursor 222 shown on the computer monitor 22 is correspondingly moved in response to the movement of the user's palm P. That is, if the palm P of the first user is moved forwardly in the positive direction of the first original axis Y, the cursor 222 shown on the computer monitor 22 is moved upwardly. Whereas, if the palm P of the first user is moved rightwards in the positive direction of the second original axis X, the cursor 222 shown on the computer monitor 22 is moved rightwards.

FIG. 3B is a schematic top view illustrating the conventional mouse operated by a first user. In this situation, the mouse 1 is operated by a second user (not shown), which is located at a right side of the first user (not shown). Since the first user is located at the proper position of operating the mouse 1, the palm P′ of the second user at the right side of the first user is usually transversely placed on the casing 10 (see FIG. 10). As shown, the palm P′ of the second user is tilted by 90 degrees with respect to the original coordinate system X-Y. Consequently, if the palm P′ of the second user is moved forwardly in the negative direction of the second original axis X, the cursor 222 shown on the computer monitor 22 is moved leftwards. Whereas, if the palm P′ of the second user is moved rightwards in the positive direction of the first original axis Y, the cursor 222 shown on the computer monitor 22 is moved leftwards, the cursor 222 shown on the computer monitor 22 is moved upwardly. For solving the above drawbacks, the second user should change the orientation of the mouse 1 to have the palm P′ coincide with the original coordinate system X-Y.

From the above discussions, it is necessary to have the user's palm coincide with the preset original coordinate system to accurately operate the mouse. That is, before the conventional mouse is operated by each user, the orientation of the conventional mouse should be adjusted to have the user's palm coincide with the original coordinate system. If the user's palm is not in coincidence with the original coordinate system, the cursor fails to be accurately moved by operating the mouse.

### SUMMARY OF THE INVENTION

The present invention relates to non-directional mouse capable of adjusting the coordinate system according to the hand gesture of the user.

In accordance with an aspect of the present invention, there is provided a non-directional mouse. The non-directional mouse is placed on a working surface and electrically connected with a computer system. The non-directional mouse includes a casing, plural touch-sensitive modules, a printed circuit board and a controlling unit. The plural touch-sensitive modules are disposed within the casing for detecting a first finger position of a first finger and a second finger position of a second finger when the first finger and the second finger are placed on an outer surface of the casing. The first finger position and the second finger position collectively define an operating coordinate system. The operating coordinate system includes a first operating axis and a second operating axis. The second operating axis is perpendicular to the first operating axis. The printed circuit board is disposed within the casing. The displacement sensing element is disposed on the printed circuit board for detecting movement of the casing on the working surface, thereby issuing a displacement signal. The displacement sensing element has a preset original coordinate system. The original coordinate system includes a first original axis and a second original axis. The controlling unit is disposed on the printed circuit board and electrically connected with the plural touch-sensitive modules and the displacement sensing element. The controlling unit is for determining the operating coordinate system according to the first finger position and the second finger position and generating a compensation displacement amount according to the displacement signal and an included angle between the first operating axis and the first original axis.

In an embodiment, the first original axis of the original coordinate system is a vertical axis, the second original axis of the original coordinate system is a horizontal axis, and the included angle between the first operating axis and the first original axis is equal to an included angle between the second operating axis and the second original axis. The first operating axis is a bisector of an angle between a first line passing through the first finger position and the displacement sensing element and a second line passing through the second finger position and the displacement sensing element. The second operating axis is perpendicular to the first operating axis.

In an embodiment, the displacement signal contains a displacement amount of the original coordinate system. The controlling unit acquires the compensation displacement amount of the operating coordinate system according to the displacement amount and the included angle between the first operating axis and the first original axis, and issues a compensation displacement signal containing the compensation displacement amount to the computer system.

In an embodiment, the non-directional mouse further includes a wireless signal transmitter and a wireless signal receiver. The wireless signal transmitter is disposed on the printed circuit board for issuing the compensation displacement signal. The wireless signal receiver is connected with the computer system for receiving the compensation displacement signal, so that the computer system executes a command to move a cursor according to the compensation displacement signal.

In an embodiment, when the outer surface of the casing is clicked by the first finger and the second finger is placed on the outer surface, a corresponding touch-sensitive module issues a first pressing signal. Whereas, when the outer surface of the casing is clicked by the second finger and the first finger is placed on the outer surface, a corresponding touch-sensitive module issues a second pressing signal. Whereas, when the first finger or the second finger is moved on the outer surface and the movement of the first finger or the second finger is detected by a corresponding touch-sensitive module, the corresponding touch-sensitive module issues a scrolling signal.

In an embodiment, each of the touch-sensitive modules includes plural touch-sensitive elements, which are arranged in a row. When the first finger or the second finger is detected by the plural touch-sensitive elements sequentially, the touch-sensitive module corresponding to the plural touch-sensitive elements issues the scrolling signal.

In an embodiment, the non-directional mouse further includes a flat flexible circuit board, which is disposed on an inner surface of the casing and electrically connected with the printed circuit board. The plural touch-sensitive modules are disposed on the flat flexible circuit board. Each of the touch-sensitive elements is a capacitive touch-sensitive element.

In an embodiment, the plural touch-sensitive modules are disposed on the printed circuit board. Each of the touch-sensitive elements is a capacitive touch-sensitive element.

In an embodiment, the non-directional mouse further includes a wireless signal transmitter and a wireless signal receiver. The wireless signal transmitter is disposed on the printed circuit board for issuing the first pressing signal, the second pressing signal and the scrolling signal. The wireless signal receiver is connected with the computer system for receiving the first pressing signal, the second pressing signal and the scrolling signal.

In an embodiment, the displacement sensing element further includes a light source, a reflective mirror, a focusing lens and an optical sensing. The light source is used for emitting a light beam and projecting the light beam on the working surface. The reflective mirror is used for reflecting the light beam. The focusing lens is used for focusing the light beam that is reflected by the working surface. The optical sensing element is used for generating the displacement signal according to the light beam.

In an embodiment, the casing is hemisphere-shaped and divided into plural fan-shaped zones, wherein the touch-sensitive modules are disposed under respective fan-shaped zones.

In an embodiment, the casing is circular disc-shaped and divided into plural fan-shaped zones, wherein the touch-sensitive modules are disposed under respective fan-shaped zones.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the connection between a conventional mouse and a computer system;

FIG. 2 schematically illustrates conventional mouse in a usage status;

FIG. 3A is a schematic top view illustrating the conventional mouse operated by a first user;

FIG. 3B is a schematic top view illustrating the conventional mouse operated by a first user;

FIG. 4 schematically illustrates the connection between a non-directional mouse and a computer system according to the present invention;

FIG. 5 is a schematic cross-sectional side view illustrating a first exemplary non-directional mouse of the present invention;

FIG. 6 is a schematic top view illustrating the non-directional mouse of FIG. 5;

FIG. 7 is a schematic perspective view illustrating the first exemplary non-directional mouse operated by a first user;

FIG. 8 is a schematic top view illustrating the first exemplary non-directional mouse operated by the first user;

FIG. 9 is a schematic top view illustrating the first exemplary non-directional mouse operated by a second user; and

FIG. 10 is a schematic cross-sectional side view illustrating a second exemplary non-directional mouse of the present invention.

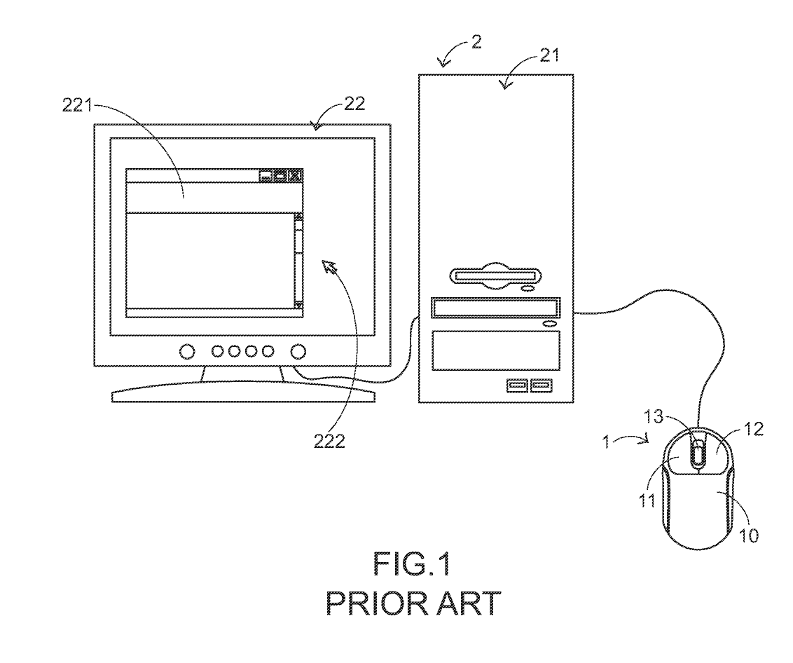

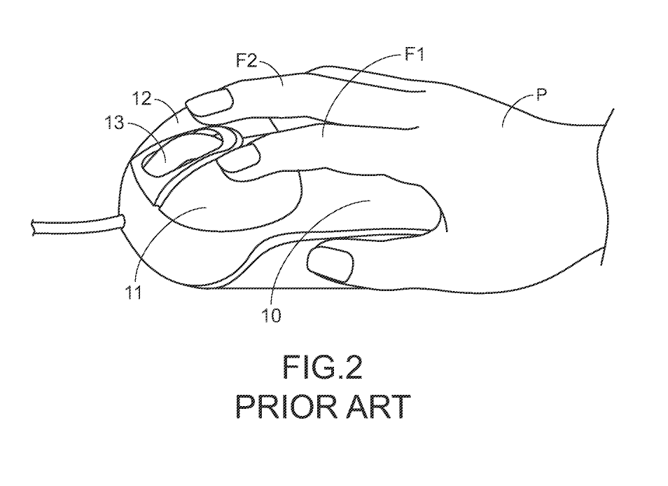

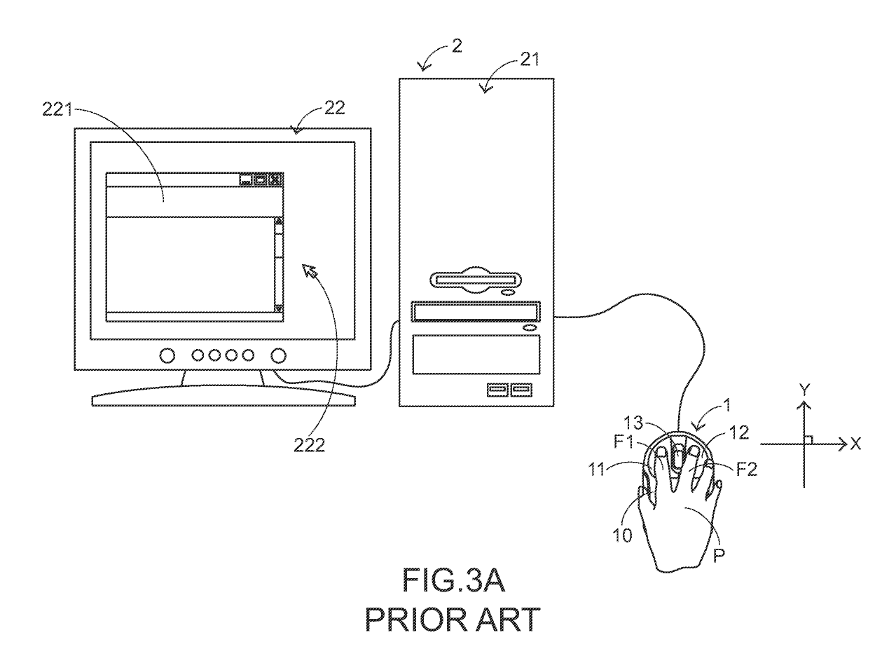

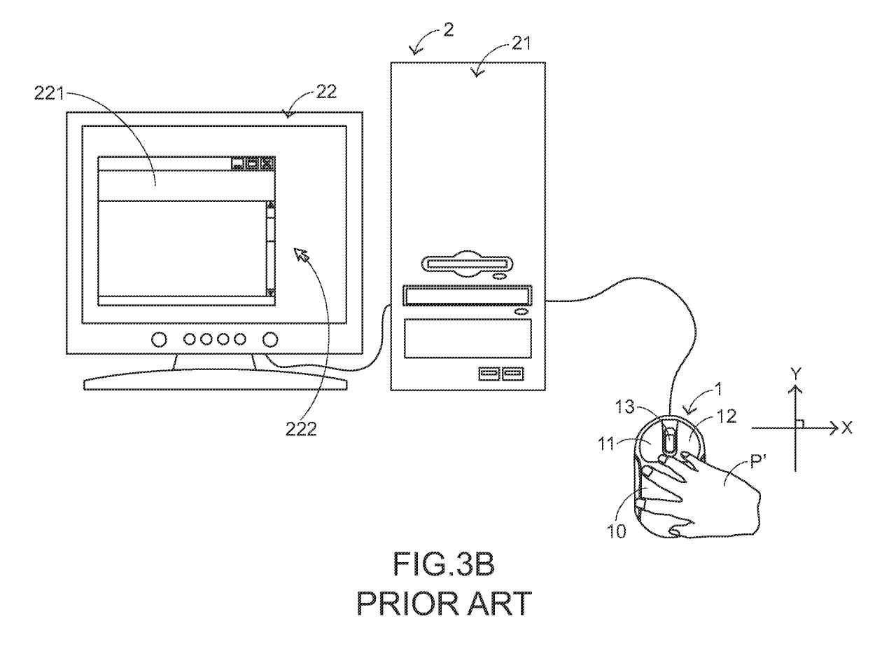

### DETAILED DESCRIPTION OF THE PREFERRED EMBODIMENT

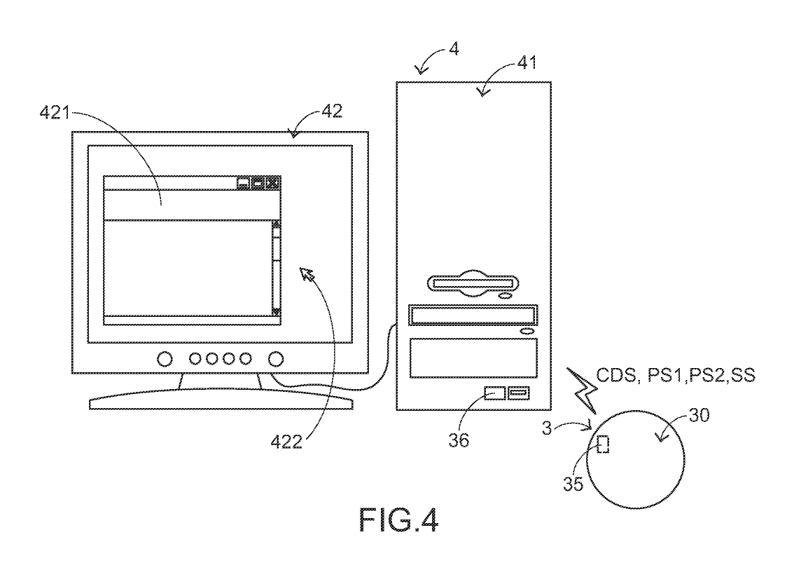

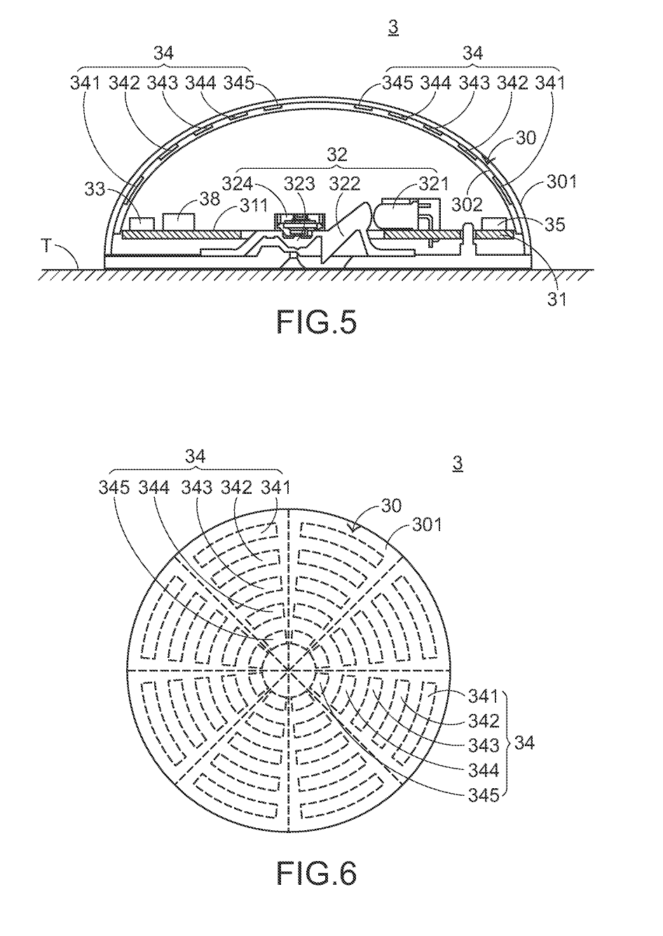

For obviating the drawbacks encountered from the prior art, the present invention provides a non-directional mouse. FIG. 4 schematically illustrates the connection between a non-directional mouse and a computer system according to the present invention. FIG. 5 is a schematic cross-sectional side view illustrating a first exemplary non-directional mouse of the present invention. Please refer to FIGS. 4 and 5. The non-directional mouse 3 comprises a casing 30, a printed circuit board 31, a displacement sensing element 32, a controlling unit 33, plural touch-sensitive modules 34, a wireless signal transmitter 35, a wireless signal receiver 36, a flat flexible circuit board 37 and a battery 38.

As shown in FIGS. 4 and 5, the displacement sensing element 32 is disposed within the casing 30 and arranged at the middle portion of the casing 30. An original coordinate system X-Y has been previously set in the displacement sensing element 32. The original coordinate system X-Y comprises a first original axis Y and a first original axis X. The original coordinate system X-Y comprises a first original axis Y and a second original axis X. The second original axis X is perpendicular to the first original axis Y. In this embodiment, the first original axis Y is a vertical axis, and the second original axis X is a horizontal axis.

The wireless signal transmitter 35 is disposed within the casing 30 for issuing a compensation displacement signal CDS, a first pressing signal PS1, a second pressing signal PS2 and a scrolling signal SS in a wireless transmission manner. The wireless signal receiver 36 is connected with the a computer host 41 of a computer system 4 for receiving the compensation displacement signal CDS, the first pressing signal PS1, the second pressing signal PS2 and the scrolling signal SS from the wireless signal transmitter 35. In response to these signals, the computer host 41 executes corresponding commands. Moreover, the computer system 4 further comprises a computer monitor 42. The computer monitor 42 is in communication with the computer host 41 for showing a graphic-based window 421 and a cursor 422.

Please refer to FIG. 5 again. The printed circuit board 31 is disposed within the casing 30. The displacement sensing element 32 is disposed on the printed circuit board 31. The displacement sensing element 32 comprises a light source 321, a reflective mirror 322, a focusing lens 323 and an optical sensing element 324. The light source 321 and the optical sensing element 324 are both disposed on a first surface 311 of the printed circuit board 31. The light source 321 is used for emitting a light beam (not shown) and projecting the light beam onto a working surface T. The reflective mirror 322 and the focusing lens 323 are integrally formed, and penetrated through the printed circuit board 31. The reflective mirror 322 is used for reflecting the light beam. The light beam reflected by the working surface T may be focused by the focusing lens 323. After the focused light beam is received by the optical sensing element 324, the optical sensing element 324 issues a displacement signal. An example of the light source 321 is a light emitting diode (LED). An example of the optical sensing element 324 includes but is not limited to a charge coupled device (CCD) or a complementary metal-Oxide-semiconductor (CMOS).

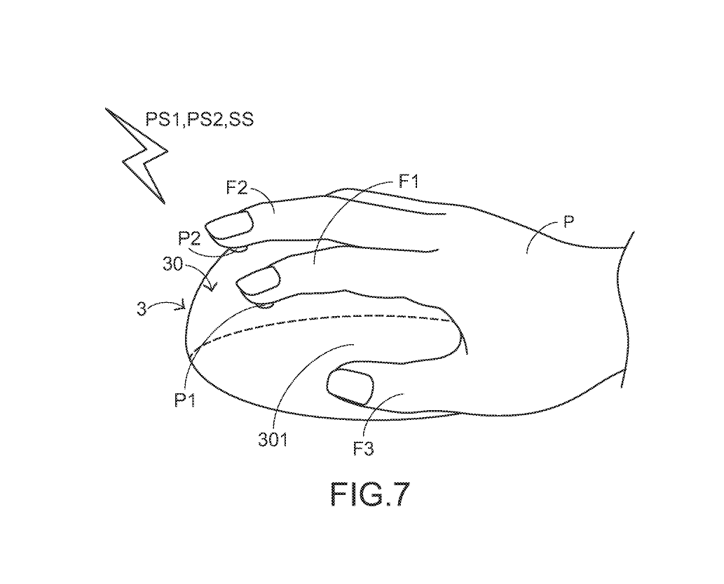

Please refer to FIG. 5 again. The plural touch-sensitive modules 34 are disposed on the flat flexible circuit board 37. In addition, the flat flexible circuit board 37 is disposed on an inner surface 302 of the casing 30, and electrically connected with the printed circuit board 31. The plural touch-sensitive modules 34 are used for detecting a first finger F1 (see FIG. 7) and a second finger F2 (see FIG. 7), which are placed on an outer surface 301 of the casing 30, thereby acquiring a first finger position P1 (see FIG. 7) of the first finger F1 and a second finger position P2 (see FIG. 7) of the second finger F2. In this embodiment, the casing 30 is a hemisphere-shaped casing. The hemisphere-shaped casing 30 may be divided into plural fan-shaped zones. Each of the touch-sensitive modules 34 is disposed under a corresponding fan-shaped zone. In addition, each of the touch-sensitive modules 34 comprises plural touch-sensitive elements 341, 342, 343, 344 and 345. The touch-sensitive elements 341, 342, 343, 344 and 345 are used for detecting an action of the first finger F1 or the second finger F2 on the outer surface 301 of the casing 30. As shown in FIGS. 5 and 6, the touch-sensitive elements 341, 342, 343, 344 and 345 of each touch-sensitive module 34 are arranged in a row. The wireless signal transmitter 35, the controlling unit 33 and the battery 38 are also disposed on the first surface 311 of the printed circuit board 31. The controlling unit 33 is electrically connected with the plural touch-sensitive modules 34 and the displacement sensing element 32 through the printed circuit board 31. The battery 38 is used for providing electricity. In this embodiment, the touch-sensitive elements 341, 342, 343, 344 and 345 of each touch-sensitive module 34 are capacitive touch-sensitive elements. An example of the controlling unit 33 is a micro processor. An example of the battery 38 is a chargeable battery.

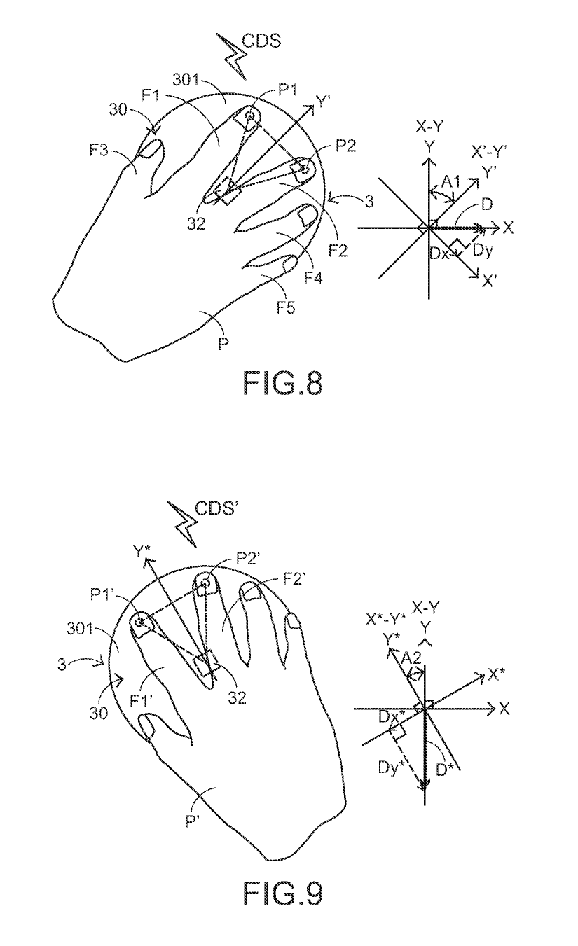

Hereinafter, the operations of the non-directional mouse 3 will be illustrated with reference to FIGS. 7 and 8. FIG. 7 is a schematic perspective view illustrating the first exemplary non-directional mouse operated by a first user. FIG. 8 is a schematic top view illustrating the first exemplary non-directional mouse operated by the first user. When the first user wants to operate the non-directional mouse 3, the palm P of the first user is placed on the outer surface 301 of the casing 30 and supported by the casing 30. In addition, the first finger F1 of the first user is placed on the outer surface 301 of the casing 30 and detected by an touch-sensitive module 34, so that the position of the first finger F1 (i.e. the first finger position P1) is acquired. Similarly, the second finger F2 of the first user is placed on the outer surface 301 of the casing 30 and detected by another touch-sensitive module 34, so that the position of the second finger F2 (i.e. the second finger position P2) is acquired. The second finger position P2 is disposed beside the first finger position P1. In this situation, the first finger position P1 and the second finger position P2 collectively define a first operating coordinate system X′-Y′. The first operating coordinate system X′-Y′ comprises a first operating axis Y′ and a second operating axis X′. The second operating axis X′ is perpendicular to the first operating axis Y′. As shown in FIG. 8, there is an included angle A1 (e.g. positive 45 degrees) between the first operating axis Y′ and the first original axis Y. That is, the angle between the first operating coordinate system X′-Y′ and the original coordinate system X-Y is equal to the included angle A1.

Please refer to FIG. 7 again. When the outer surface 301 of the casing 30 is clicked by the first finger F1 of the first user and the second finger F2 is placed on the outer surface 301 of the casing 30, the touch-sensitive modules 34 detect that the second finger position P2 is unchanged. Moreover, since the first finger F1 is departed from the outer surface 301 and then placed on the outer surface 301 again, the touch-sensitive modules 34 detect that the first finger position P1 is slightly changed. Under this circumstance, the touch-sensitive modules 34 issue a first pressing signal PS1, which is equivalent to the signal generated by clicking the left button 11 of the conventional mouse 1. By the controlling unit 33, the first pressing signal PS1 is transmitted to the computer host 41 through the wireless signal transmitter 35 and the wireless signal receiver 36. In response to the first pressing signal PS1, the computer host 41 executes a corresponding command.

Similarly, when the outer surface 301 of the casing 30 is clicked by the second finger F2 of the first user and the first finger F1 is placed on the outer surface 301 of the casing 30, the touch-sensitive modules 34 detect that the first finger position P1 is unchanged. Moreover, since the second finger F2 is departed from the outer surface 301 and then placed on the outer surface 301 again, the touch-sensitive modules 34 detect that the second finger position P2 is slightly changed. Under this circumstance, the touch-sensitive modules 34 issue a second pressing signal PS2, which is equivalent to the signal generated by clicking the right button 12 of the conventional mouse 1. By the controlling unit 33, the second pressing signal PS2 is transmitted to the computer host 41 through the wireless signal transmitter 35 and the wireless signal receiver 36. In response to the second pressing signal PS2, the computer host 41 executes a corresponding command.

When the first finger F1 or the second finger F2 is moved on the outer surface 301 of the casing 30 and the movement of the first finger F1 or the second finger F2 is detected by a corresponding touch-sensitive module 34 (i.e. the touch-sensitive elements 341, 342, 343, 344 and 345 are sequentially triggered), the triggered touch-sensitive module 34 issues a scrolling signal SS, which is equivalent to the signal generated by scrolling the scroll wheel 13 of the conventional mouse 1. By the controlling unit 33, the scrolling signal SS is transmitted to the computer host 41 through the wireless signal transmitter 35 and the wireless signal receiver 36. In response to the scrolling signal SS, the computer host 41 executes a corresponding command of scrolling the graphic-based window 421.

Please refer to FIG. 8 again. When the palm P of the first user is directed in the northeast at 45 degrees to move the non-directional mouse 3 by a displacement amount D of 2 units, the displacement sensing element 32 issues a displacement signal according to the movement of the casing 30 on the working surface T (see FIG. 4), wherein the displacement signal contains the displacement amount D. As shown in FIG. 8, the displacement amount D is a displacement along the second original axis X of the original coordinate system X-Y. The displacement amount D contained in the displacement signal that is received by the controlling unit 33 indicates a two-unit displacement along the positive direction of the horizontal axis. After the displacement signal is received by the controlling unit 33, the controlling unit 33 acquires a compensation displacement amount (Dx, Dy) according to the included angle A1 between the first operating axis Y′ and the first original axis Y. That is, the preset original coordinate system X-Y is switched into the first operating coordinate system X′-Y′ by the controlling unit 33. In the first operating coordinate system X′-Y′, the displacement amount D is the magnitude of a vector having an angle of 45 degrees with respect to the second operating axis X′. Then, the horizontal component and the vertical component of the displacement amount D in the first operating coordinate system X′-Y′ will be acquired as the compensation displacement amount by the controlling unit 33. Since the included angle A1 is 45 degrees, the compensation displacement amount (Dx, Dy) acquired by the controlling unit 33 is (1.414, 1.414). That is, the displacement amount (Dx, Dy) indicates the movement of 1.414 units along the first operating axis Y′ and 1.414 units along the second operating axis X′. Afterwards, by the controlling unit 33, a compensation displacement signal CDS that contains the compensation displacement amount (Dx, Dy) is transmitted to the computer host 41 through the wireless signal transmitter 35 and the wireless signal receiver 36 (see also FIG. 4). In response to the compensation displacement signal CDS, the computer host 41 executes a corresponding command of moving the cursor 422.

As know, when the palm P of the first user is placed on the outer surface 301 of the casing 30 and the first finger F1 and the second finger F2 are placed on the outer surface 301, a third finger F3, a fourth finger F4 and a fifth finger F5 are also placed on the outer surface 301 and detected by the touch-sensitive modules 34. In this embodiment, two criteria are provided to judge which two fingers indicate the first finger F1 and the second finger F2 (i.e. the forefinger and the middle finger). The first judgment criterion is used in the case that only the tips of all fingers are in contact with the outer surface 301. The controlling unit 33 will determine the first finger F1 and the second finger F2 according to the distance between the tip of each finger and the displacement sensing element 32. That is, according to the first judgment criterion, among the five fingers F1, F2, F3, F4 and F5, the farthest two fingers relative to the displacement sensing element 32 denote the first finger F1 and the second finger F2. The second judgment criterion is used in the case that all fingers are in contact with the outer surface 301. The controlling unit 33 will determine the first finger F1 and the second finger F2 according to the contact area between each finger and the outer surface 301. That is, according to the second judgment criterion, among the five fingers F1, F2, F3, F4 and F5, the two fingers having the largest contact area with the outer surface 301 denote the first finger F1 and the second finger F2. According to the above judgment criteria, the controlling unit 33 can judge which two fingers indicate the first finger F1 and the second finger F2. Since the touch-sensitive modules 34 are not triggered by the remaining fingers F3, F4 and F5, the possibility of causing erroneous judgment of the controlling unit 33 will be minimized.

FIG. 9 is a schematic top view illustrating the first exemplary non-directional mouse operated by a second user. When a second user located at a side of the first user wants to operate the non-directional mouse 3, the palm P′ of the second user is placed on the outer surface 301 of the casing 30 and supported by the casing 30. In addition, the first finger F1′ of the second user is placed on the outer surface 301 of the casing 30 and detected by an touch-sensitive module 34, so that the position of the first finger F1′ (i.e. the first finger position P1′) is acquired. Similarly, the second finger F2′ of the second user is placed on the outer surface 301 of the casing 30 and detected by another touch-sensitive module 34, so that the position of the second finger F2′ (i.e. the second finger position P2′) is acquired. The second finger position P2′ is disposed beside the first finger position P1′. In this situation, the first finger position P1′ and the second finger position P2′ collectively define a second operating coordinate system X*-Y*. The second operating coordinate system X*-Y* comprises a first operating axis Y* and a second operating axis X*. The second operating axis X* is perpendicular to the first operating axis Y*. As shown in FIG. 9, there is an included angle A2 (e.g. negative 30 degrees) between the first operating axis Y* and the first original axis Y. That is, the angle between the second operating coordinate system X*-Y* and the original coordinate system X-Y is equal to the included angle A2.

The operating principles of clicking the casing 30 of the non-directional mouse 3 to generate the first pressing signal or the second pressing signal and the operating principles of moving the non-directional mouse 3 to generate the scrolling signal when the non-directional mouse 3 are operated by the second user are similar to those operated by the first user, and are not redundantly described herein. Please refer to FIG. 9 again. When the palm P′ of the second user is directed in the source to move the non-directional mouse 3 by a displacement amount D* of 2 units, the displacement sensing element 32 issues a displacement signal according to the movement of the casing 30 on the working surface T (see FIG. 4), wherein the displacement signal contains the displacement amount D*.

As shown in FIG. 9, the displacement amount D is a displacement along the first original axis Y of the original coordinate system X-Y. The displacement amount D* contained in the displacement signal that is received by the controlling unit 33 indicates a two-unit displacement along the negative direction of the vertical axis. The displacement sensing element 32 issues a displacement signal according to the movement of the casing 30 on the working surface T, wherein the displacement signal contains the displacement amount D*.

After the displacement signal is received by the controlling unit 33, the controlling unit 33 acquires a compensation displacement amount (Dx*, Dy*) according to the included angle A2 between the first operating axis Y* and the first original axis Y. That is, the preset original coordinate system X-Y is switched into the second operating coordinate system X*-Y* by the controlling unit 33. In the second operating coordinate system X*-Y*, the displacement amount D* is the magnitude of a vector having an angle of 30 degrees with respect to the second operating axis X*. Then, the horizontal component and the vertical component of the displacement amount D* in the second operating coordinate system X*-Y* will be acquired as the compensation displacement amount (Dx*, Dy*) by the controlling unit 33. Since the included angle A2 is 30 degrees, the compensation displacement amount (Dx*, Dy*) acquired by the controlling unit 33 is (−1, −1.732). That is, the displacement amount (Dx*, Dy*) indicates the movement of 1.732 units along the first operating axis Y* and 1 units along the second operating axis X. Afterwards, by the controlling unit 33, a compensation displacement signal CDS* that contains the compensation displacement amount (Dx*, Dy*) is transmitted to the computer host 41 through the wireless signal transmitter 35 and the wireless signal receiver 36. In response to the compensation displacement signal CDS*, the computer host 41 executes a corresponding command of moving the cursor 422. The configurations and operations of the first exemplary non-directional mouse 3 have been described as above.

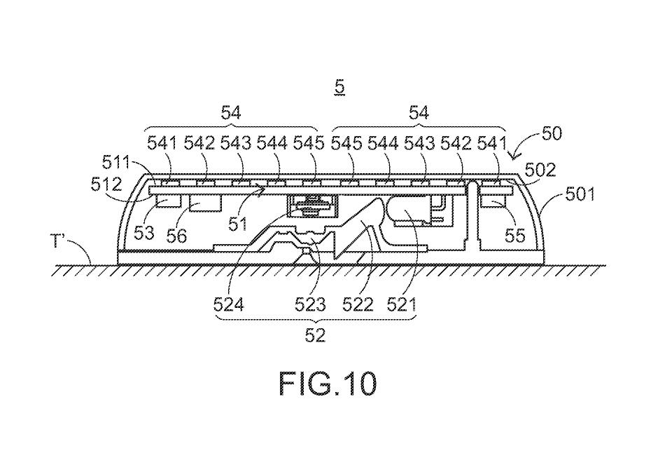

FIG. 10 is a schematic cross-sectional side view illustrating a second exemplary non-directional mouse of the present invention. The non-directional mouse 5 is placed on a working surface T′. The non-directional mouse 5 comprises a casing 50, a printed circuit board 51, a displacement sensing element 52, a controlling unit 53, plural touch-sensitive modules 54, a wireless signal transmitter 55, a wireless signal receiver (not shown) and a battery 56. The printed circuit board 51 is disposed within the casing 50. The displacement sensing element 52 is disposed on the printed circuit board 51. The displacement sensing element 52 comprises a light source 521, a reflective mirror 522, a focusing lens 523 and an optical sensing element 524. The light source 521 and the optical sensing element 524 are both disposed on a second surface 512 of the printed circuit board 51. The reflective mirror 522 and the focusing lens 523 are integrally formed, and disposed under the printed circuit board 51. The wireless signal transmitter 55, the controlling unit 53 and the battery 56 are all disposed on the second surface 512 of the printed circuit board 51. The controlling unit 53 is electrically connected with the plural touch-sensitive modules 54 and the displacement sensing element 52 through the printed circuit board 51.

Please refer to FIG. 10 again. The plural touch-sensitive modules 54 are disposed on a first surface 511 of the printed circuit board 51. Each of the touch-sensitive modules 54 comprises plural touch-sensitive elements 541, 542, 543, 544 and 545. In addition, the touch-sensitive elements 541, 542, 543, 544 and 545 of each touch-sensitive module 54 are arranged in a row. These touch-sensitive elements 541, 542, 543, 544 and 545 are disposed on the first surface 511 of the printed circuit board 51 and in contact with the inner surface 502 of the casing 50 for detecting the actions of a first finger (not shown) and a second finger (not shown), which are placed on an outer surface 501 of the casing 50. In this embodiment, the casing 50 is a circular disc-shaped casing. The circular disc-shaped casing 50 may be divided into plural fan-shaped zones. Each of the touch-sensitive modules 54 is disposed under a corresponding fan-shaped zone. Except for the locations, the functions of other components included in the non-directional mouse 5 are similar to those of the first exemplary non-directional mouse, and are not redundantly described herein.

From the above description, the non-directional mouse of the present invention can determine the operating coordinate systems corresponding to different users according to the positions of the first fingers and the second fingers of different users. Moreover, the button positions of the non-directional mouse of the present invention are determined according to the positions of the user's fingers. In a case that the non-directional mouse is operated by many users, the non-directional mouse can generate corresponding operating coordinate systems and the left pressing, right pressing and scrolling signals without the need of changing the orientation of the mouse.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A non-directional mouse placed on a working surface and electrically connected with a computer system, said non-directional mouse comprising:
a casing;
plural touch-sensitive modules disposed within said casing for detecting a first finger position of a first finger and a second finger position of a second finger when said first finger and said second finger are placed on an outer surface of said casing, wherein said first finger position and said second finger position collectively define an operating coordinate system, wherein said operating coordinate system comprises a first operating axis and a second operating axis perpendicular to said first operating axis;
a printed circuit board disposed within said casing;
a displacement sensing element disposed on said printed circuit board for detecting movement of said casing on said working surface, thereby issuing a displacement signal, wherein said displacement sensing element has a preset original coordinate system, wherein said original coordinate system comprises a first original axis and a second original axis; and
a controlling unit disposed on said printed circuit board and electrically connected with said plural touch-sensitive modules and said displacement sensing element for determining said operating coordinate system according to said first finger position and said second finger position and generating a compensation displacement amount according to said displacement signal and an included angle between said first operating axis and said first original axis.

2. The non-directional mouse according to claim 1 wherein said first original axis of said original coordinate system is a vertical axis, said second original axis of said original coordinate system is a horizontal axis, and said included angle between said first operating axis and said first original axis is equal to an included angle between said second operating axis and said second original axis, wherein said first operating axis is a bisector of an angle between a first line passing through said first finger position and said displacement sensing element and a second line passing through said second finger position and said displacement sensing element, wherein said second operating axis is perpendicular to said first operating axis.

3. The non-directional mouse according to claim 1 wherein said displacement signal contains a displacement amount of said original coordinate system, wherein said controlling unit acquires said compensation displacement amount of said operating coordinate system according to said displacement amount and said included angle between said first operating axis and said first original axis, and issues a compensation displacement signal containing said compensation displacement amount to said computer system.

4. The non-directional mouse according to claim 3 further comprising:
a wireless signal transmitter disposed on said printed circuit board for issuing said compensation displacement signal; and
a wireless signal receiver connected with said computer system for receiving said compensation displacement signal, so that said computer system executes a command to move a cursor according to said compensation displacement signal.

5. The non-directional mouse according to claim 1 wherein when said outer surface of said casing is clicked by said first finger and said second finger is placed on said outer surface, a corresponding touch-sensitive module issues a first pressing signal, wherein when said outer surface of said casing is clicked by said second finger and said first finger is placed on said outer surface, a corresponding touch-sensitive module issues a second pressing signal, wherein when said first finger or said second finger is moved on said outer surface and the movement of said first finger or said second finger is detected by a corresponding touch-sensitive module, said corresponding touch-sensitive module issues a scrolling signal.

6. The non-directional mouse according to claim 5 wherein each of said touch-sensitive modules comprises plural touch-sensitive elements, which are arranged in a row, wherein when said first finger or said second finger is detected by said plural touch-sensitive elements sequentially, said touch-sensitive module corresponding to said plural touch-sensitive elements issues said scrolling signal.

7. The non-directional mouse according to claim 6 further comprising a flat flexible circuit board, which is disposed on an inner surface of said casing and electrically connected with said printed circuit board, wherein said plural touch-sensitive modules are disposed on said flat flexible circuit board, and each of said touch-sensitive elements is a capacitive touch-sensitive element.

8. The non-directional mouse according to claim 6 wherein said plural touch-sensitive modules are disposed on said printed circuit board, and each of said touch-sensitive elements is a capacitive touch-sensitive element.

9. The non-directional mouse according to claim 5 further comprising:
a wireless signal transmitter disposed on said printed circuit board for issuing said first pressing signal, said second pressing signal and said scrolling signal; and
a wireless signal receiver connected with said computer system for receiving said first pressing signal, said second pressing signal and said scrolling signal.

10. The non-directional mouse according to claim 1 wherein said displacement sensing element further comprises:
a light source for emitting a light beam and projecting said light beam on said working surface;
a reflective mirror for reflecting said light beam;
a focusing lens for focusing said light beam that is reflected by said working surface; and
an optical sensing element for generating said displacement signal according to said light beam.

11. The non-directional mouse according to claim 1 wherein said casing is hemisphere-shaped and divided into plural fan-shaped zones, wherein said touch-sensitive modules are disposed under respective fan-shaped zones.

12. The non-directional mouse according to claim 1 wherein said casing is circular disc-shaped and divided into plural fan-shaped zones, wherein said touch-sensitive modules are disposed under respective fan-shaped zones.
